(19) United States
(12) Patent Application Publication
(10) Pub. No.: US 2023/0138115 A1
(43) Pub. Date: May 4, 2023

(54) METHOD AND DEVICE FOR PRODUCING A FOOD PRODUCT

(71) Applicant: Hebenstreit GmbH, Mörfelden-Walldorf (DE)

(72) Inventors: Friedrich DUSCHKA, Dresden (DE); Ralph Olaf FÖRSTER, Dresden (DE); Egbert MERFORTH, Dresden (DE); Michael ENGELMANN, Bischofsheim (DE); Antonius ROLF-WITTLAKE, Friesoythe-Thüle (DE)

(73) Assignee: Hebenstreit GmbH, Mörfelden-Walldorf (DE)

(21) Appl. No.: 17/802,426

(22) PCT Filed: Feb. 15, 2021
(86) PCT No.: PCT/EP2021/053664

§ 371 Date: Oct. 31, 2022

(30) Foreign Application Priority Data
Feb. 27, 2020 (DE) 10 2020 105 228.6

(51) Int. Cl. A23P 30/20; B29C 48/50; B29C 48/285

(52) U.S. Cl. CPC A23P 30/20; B29C 48/501; B29C 48/298; A23L 7/117

(57) ABSTRACT

A raw material mixture is supplied to an extrusion machine by a moved supply unit in a particularly uniform manner. The raw material mixture has a fiber raw material and a carrier raw material. The fiber raw material has a process by-product of a food manufacturing process and the carrier raw material has whole-grain components. A raw material quantity is supplied by the supply unit along a trajectory through the supply opening into the production machine. The trajectory of the raw material quantity is changeable. The supply unit has at least one actuating unit, by which an actuating movement of the supply channel portion and/or of the feed hopper can be generated, so that the supply channel portion can be caused to displace relative to the feed hopper.

### TECHNICAL FIELD

The present disclosure relates to a method for processing a raw material mixture in an extrusion machine for manufacturing a food product.

### BACKGROUND

It is known to use extrusion processes in food production for the production of pasta, snack foods or for the manufacture of breakfast cereals. The extrusion process is carried out by means of an extrusion machine, which can be configured as a single-screw extrusion machine or a twin-screw extrusion machine, for example. Under the influence of pressure and temperature, the raw material to be processed or the raw material mixture is pressed through a defined opening, for example a nozzle, and the solidified extrudate is shaped at the outlet of the nozzle with the aid of a cutting device. During the extrusion process, the raw material to be processed undergoes a chemical or physical modification, whereby the extrudate properties or the properties of the product can be adjusted. The extrudate properties, such as a texture, a density, a moisture content or a porosity, are determined both by the raw material properties and by the extrusion parameters, such as a configuration and a type of extruder, a screw speed, an input of thermal and mechanical energy, a diameter and a type of die. In order to obtain extrudate with a consistent consistency and composition, the raw materials of the raw material mixture should be supplied to the extrusion machine as uniformly as possible. In order to be able to supply the raw materials uniformly to the extrusion machine, the raw materials must have certain raw material properties, in particular good flowability or good pourability. In order to adjust the raw material properties with regard to good flowability or good pourability, some preparatory steps are necessary depending on the raw material. A raw material can also be present, for example, in a powdery, floury or grit-like state and only be processed into an extrudable raw material by adding water or another suitable liquid binder. The liquid can be added to the raw material in advance and the extrudable raw material supplied to the extrusion machine. It is also possible and practicable to supply the raw material that is not yet extrudable and the liquid separately to the extrusion machine in order to produce an extrudable raw material mixture in the extrusion machine.

When processing a whole-grain flour or meal, raw material mixtures with a high fiber content are produced due to the contained hull components of the grain. A high proportion of fibers within a raw material mixture can lead to poor flowability or poor pourability of the raw material mixture, making the raw material mixture difficult to convey and creating a risk of bridging within the supply unit. Such bridging can cause the supply unit to become blocked, so that no further raw material quantity can be supplied into the production machine. The cause of bridging is the adhesive forces between the individual raw material particles in the case of fine-grained raw material quantities, for example fine-grained, cohesive raw material particles. With coarse-grained raw materials, the cause of bridging is a wedging of the raw material particles. Thus, when bridging occurs and a further raw material quantity is supplied into the region of the bridge, an excess raw material quantity is produced, which leads to a blockage of the supply unit. Depending on the nature of the raw material quantity and the configuration of the supply unit, the bridges can dissolve again and cause a further feeding of the raw material quantity into the production machine, which unfavorably results in an irregular supply of the raw material quantity into the production machine and a consistent consistency and composition of the extrudate cannot be ensured. Such raw material quantities, where there is a high risk of bridging when supplied, are considered to have poor flowability and are therefore difficult to convey.

High-quality process by-products such as press cakes or filter cakes are known from food production. Press cake, also known as pomace, is food residue that remains after the juice of fruit, vegetables or plant components has been squeezed out. Press cakes are known to be used in the food industry for the manufacture of spirits, in the animal feed industry as animal feed or for energetic use for energy recovery by means of biogas plants. Such press cakes and filter cakes have high-quality fruit, vegetable or plant components, but direct further processing of the press cakes and filter cakes into food products is usually not intended. In some cases, further processing of the press cakes is only possible after drying, which is time-consuming, energy-intensive and therefore costly. Therefore, the process by-products are often not reused but disposed of.

### SUMMARY

It is considered to be the object of the present disclosure to provide a method for processing a raw material mixture having a process by-product of a food manufacturing process with a high proportion of fibers into a food product in an extrusion machine.

This object is achieved by a method in which the raw material mixture is supplied to the extrusion machine by means of the moved supply unit, wherein the raw material mixture is adjustable at different feed positions within the supply opening by the actuating movement of the supply channel portion and/or the feed hopper of the supply unit, which enables a particularly uniform supply of the raw material quantity into the extrusion machine, so that the raw material mixture can be processed by means of the extrusion machine, wherein the raw material mixture has a fiber raw material and a carrier raw material, wherein the fiber raw material has a process by-product of a food manufacturing process, and wherein the carrier raw material has whole-grain components.

The fact that the actuating unit can be used to generate different forms of movement and speeds of movement, such as circular, zigzag, fast or slow movements, means that the poorly flowable and poorly conveyable raw material mixtures can be stimulated to flow particularly advantageously. Due to a high flowability and a good conveyability of the raw material mixture, bridging can be avoided in a particularly advantageous way, so that the raw material mixture is made conveyable by means of the moved supply unit and can be uniformly supplied into the production machine, whereby a consistent consistency and composition of the extrudate can be advantageously ensured.

Process by-products made from, for example, a juice manufacturing process are press cakes and filter cakes, which contain skin, pulp, seeds and residual juice from berries or grapes. By further processing the process by-products, the quantity of by-products from food manufacturing processes that have to be disposed of as waste can be reduced in an advantageous way. It is understood that a whole-grain flour has all the components of the whole grain such as the bran, germ and endosperm. By processing the whole-grain flour into a carrier, upstream separation processes for separating the bran from the other components of the whole grain can be saved to particular advantage, thus enabling particularly economical food manufacturing. By processing the whole grain including the germ, the endosperm and in particular including the high-fiber hull, a high-fiber food product can be manufactured particularly advantageously. Due to the particularly beneficial nutritive properties of the high-fiber food products, low-sugar and low-fat and thus health-promoting food products can be manufactured. By using the extrusion process to process by-products from food processing methods, various product shapes and thus entirely new food products can be configured and manufactured from the high-quality components of the process by-products. For example, as a substitute for snack foods, such as crisps or peanut puffs, novel extruded snacks can be created, such as puffs, rings and any other extrudable shapes, or snack products, such as bars, can be manufactured to replace or supplement the consumption of fruits or vegetables.

Advantageously, it is provided that the raw material mixture has 5 wt. % to 80 wt. % fiber raw material and 1 wt. % to 95 wt. % carrier raw material. The properties of the extruded food product, such as texture, density and porosity, are determined by the raw material properties, the extrusion parameters and/or the recipe of the raw material mixture. A high proportion of fiber raw materials in the range of 40 wt. % to 80 wt. % within the raw material mixture results in harder and finer-pored extrudate. A high proportion of carrier raw materials in the range of 50 wt. % to 95 wt. % leads to a greater expansion of the extrudate and thus to large pores. Thus, by changing the composition of the raw material mixture, the extrudate properties and thus the properties of the extruded food product can be influenced in a particularly advantageous way.

In an advantageous manner, it is optionally possible for the proportion of the process by-product in the fiber raw material to be 1 wt. % to 100 wt. %, whereby the extrudate properties can be adjusted particularly advantageously by the composition of the raw material mixture. A high proportion of the process by-product in the fiber raw material in the range of 60 wt. % to 100 wt. % allows a particularly high degree of reuse of the process by-product within the raw material mixture. This makes particularly economical food product manufacturing possible. By having a high proportion of the process by-product in the fiber raw material, the proportion of fibers within the raw material mixture can be increased, allowing particularly high-fiber extrudate and food products to be manufactured. With a low proportion of the process by-product in the fiber raw material in the range of 1 wt. % to 40 wt. % and with a simultaneously increased proportion of the carrier raw material in the raw material mixture, extrudate and food products with larger pores and thus with lower density can be manufactured.

An advantageous implementation optionally provides that the process by-product has plant-based raw materials consisting of press cakes, filter cakes, husks and/or spent grains.

The process by-products that arise from a juice manufacturing process, for example, are press cakes and filter cakes, which contain skins, pulp, seeds and residual juice from berries or grapes. These press cakes contain a large number of valuable ingredients, such as vitamins and dietary fibers, which are only utilized during further processing to produce a food product that is particularly rich in vitamins and dietary fibers. Press cakes can be produced, for example, by juice manufacturers, wine presses or fruit processing plants and contain different types of berries or fruit, such as stone or soft fruit, apples, cherries, elderberries, pears, rhubarb or currants. Raw material mixtures with components such as brewer's grains, grape pomace or vegetable peelings that accumulate in breweries, winegrowing operations or vegetable processing plants are also possible. Due to the further processability of the press cakes or filter cakes from different types of berries and fruits within the extrusion process, the manufacturing of a variety of different and valuable food products for human nutrition is possible.

Advantageously, it is provided that the process by-product has 5 wt. % to 20 wt. % water. For the extrusion process, moisture contents of the raw material mixtures in the range of 15 wt. % to 20 wt. % are typically but not exclusively set, so that direct further processing of the process by-products within the raw material mixture is possible by means of an extrusion process. Furthermore, a good microbiological stability of the process by-product is established by a moisture content in the range of 5 wt. % to 20 wt. %. With a moisture content of the process by-product in the range of 5 wt. % to 20 wt. %, the addition of additional water or a time- and energy-intensive drying of the raw material mixture to reduce the water content within the raw material mixture can be dispensed with for the further processing of the process by-product in the extrusion process.

Advantageously, the whole grain may be selected from maize, rice, wheat, barley, rye, oats or a combination thereof, enabling a wide variety of different extruded food products to be manufactured. Due to the high proportion of dietary fiber, minerals and vitamins within whole grains, food products valuable for human nutrition can be manufactured. Due to the high availability of raw materials, the extruded food products can also be manufactured in large quantities at economically favorable conditions.

An advantageous implementation optionally provides that the raw material mixture has at least one further component, whereby the composition of the raw material mixture can be changed. By adjusting the composition of the raw material mixture, the properties of the extrudate and the food product can be adjusted particularly advantageously. Likewise, the addition of the further component in a small amount to the raw material mixture is conceivable, wherein the further component may have a spice or a flavor. The addition of the further component can advantageously increase the variety of possible raw material mixtures and thus high-quality food products.

Advantageously, it is provided that the further component is selected from water, sweetening agents, such as sugar, sugar alcohols and sweeteners, table salt, fats and oils, functional ingredients, such as vitamins, minerals, unsaturated fatty acids and bacterial cultures, flavors and combinations thereof. Such further components serve to refine the extruded food products, whereby, for example, taste or coloring, consistency and nutritional value can be advantageously influenced. This makes it possible to manufacture particularly tasty and visually appealing food products with a high nutritional value.

It has been shown that with the method according to the disclosure it is possible to extrude almost all relevant raw material mixtures supplied to the extrusion machine with a single-screw extrusion device. By configuring and controlling the supply unit, undesirable bridging or uneven loading of the extrusion device can be avoided. In addition, the raw material mixture can be processed without further ado in a single-screw extrusion device and thus extruded without having to worry about clumping of individual components or of the extrudable raw material mixture, for example. The use of a single-screw extrusion device has significant advantages over the otherwise common use of a twin-screw extrusion device, for example, in terms of the significantly lower costs incurred for the manufacture and operation of the extrusion device.

The disclosure also relates to a method for supplying a raw material quantity into a production machine, wherein the raw material quantity can be supplied into the production machine along a trajectory through a supply opening by means of a supply unit.

Generally known from practice, such supply units are used in the food production industry to supply production machines, such as extrusion machines used for the manufacture of snacks or pasta, with raw material quantities. As an extrusion process runs continuously and continuously produces extrudate, it is also necessary to supply the extrusion machine continuously and in particular uniformly with a raw material quantity.

Supply units for extrusion machines are known from the prior art, in which the raw material quantity is supplied through a supply opening of the production machine, wherein the supply of the raw material quantity is gravity-assisted from above into the supply opening of the production machine. It is known that an extrusion machine is also used to process raw material mixtures that are composed of individual raw materials with different properties. For example, a flowable material is extruded and additional additives are supplied to it via a feed hopper. These additives are often taken from storage containers and supplied to the feed hopper of the supply unit. The additives are often supplied by gravity by trickling down from above into the feed hopper arranged below. In order to obtain extrudate with a consistent consistency and composition, the additives should be supplied to the production machine as uniformly as possible.

The additives can, for example, consist of a raw material with a high proportion of fibers and form a free-flowing raw material mixture in a dried state. It is known that raw material mixtures with a high proportion of fibers have poor flowability and are difficult to convey, which can create a risk of bridging within the supply unit. Bridging can cause the supply unit to become blocked, so that no further raw material quantity can be supplied into the production machine. The cause of bridging is the adhesive forces between the individual raw material particles in the case of fine-grained raw material quantities, for example fine-grained, cohesive raw material particles. With coarse-grained raw material quantities, the cause of bridging is a wedging of the raw material particles. Thus, when bridging occurs and a further raw material quantity is supplied into the region of the bridge, an excess raw material quantity is produced, which leads to a blockage of the supply opening of the supply unit. Depending on the nature of the raw material quantity and the configuration of the supply unit, the bridges can dissolve again and cause a further feeding of the raw material quantity into the production machine, which unfavorably results in an irregular feeding of the raw material quantity into the production machine. Such raw material quantities, where there is a high risk of bridging when supplied, are considered to have poor flowability and are therefore difficult to convey. The effort required to supply poorly flowing raw materials that are difficult to convey in a controlled and uniform manner is often considerable.

It is therefore considered to be an object of the present disclosure to configure a method for supplying a raw material quantity into a production machine in such a way that supplying the raw material quantity is possible without bridging and thus reliably and continuously.

This object is achieved by a method in which the trajectory of the raw material quantity is changeable such that a trajectory passage angle, at which the trajectory passes through the supply opening and/or a trajectory passage position at which the trajectory passes through the supply opening is changeable, whereby the raw material quantity can be distributed to different feed positions within the supply opening when being supplied into the production machine.

The trajectory of the raw material quantity is changeable in such a way that the raw material supply can, for example, be supplied laterally and in a parabolic trajectory to the supply opening. Simply by changing the trajectory passage angle, a local displacement of the raw material quantity can be brought about, so that bridging and thus a local excess raw material quantity can be avoided.

Advantageously, a raw material supply can be gravity-assisted from above into the supply opening. Advantageously achieving a local displacement of the raw material quantity within the supply opening with such a perpendicularly entering raw material supply can be achieved solely by changing the trajectory passage position. Advantageously, bridging can thus be avoided, so that a continuous and uniform supply of the raw material quantity into the production machine is possible.

Advantageously, it is provided that the trajectory passage angle and the trajectory passage position are continuously and/or discontinuously changeable during the supply of the raw material quantity through the supply opening, whereby advantageously different actuating movements adapted to the respective raw material properties is adjustable. The supply of the raw material quantity can take place during a continuous change of the trajectory passage position, wherein the trajectory passage position is carried out, for example and advantageously, in circular actuating movements along a path following the diameter of the supply opening offset inwards. However, it is also conceivable to change the trajectory passage position in slow or fast actuating movements or in oscillating and direction-changing actuating movements. This means that the raw material quantity supplied can be distributed continuously and particularly uniformly within the supply opening. By discontinuously changing the trajectory passage angle and the trajectory passage position at discrete points in time, such a supply of the raw material quantity is adjustable, whereby bridging of the raw material quantity can be avoided in a particularly advantageous manner. Discontinuous changes of the trajectory passage angle and the trajectory passage position can also be realized particularly easily.

In an advantageous manner, it is optionally possible that a change in the trajectory passage angle and a change in the trajectory passage position can be carried out at different speeds. At high speeds, where the change in the trajectory passage angle and the change in the trajectory passage position takes place, the poorly flowable and poorly conveyable raw materials can be particularly advantageously stimulated to flow. Due to a high flowability and a good conveyability of the raw material quantity, bridging can be avoided in a particularly advantageous way, so that it becomes conveyable by means of the supply unit.

The disclosure also relates to a supply unit for supplying a raw material quantity into a production machine having a supply channel portion having an exit opening and having a feed hopper, wherein the raw material quantity can be conveyed through the exit opening of the supply channel portion into a feed opening of the feed hopper and can be supplied through the feed hopper to the production machine.

Supply units for extrusion machines are known from the prior art, in which the raw material quantity is supplied to the production machine through a supply tube and through a supply hopper, wherein the supply tube is usually attached statically and stationarily above the supply hopper in order to enable gravity-assisted supply of the raw material quantity into the production machine. Due to the stationary arrangement of the supply tube above the supply hopper, bridging can occur inside the supply hopper and prevent further supply with raw material quantity. The risk of bridging within the supply hopper is also disadvantageously increased by the tapering of the cross-section of the supply hopper towards the production machine. This means that a uniform and continuous supply of the raw material quantity cannot be guaranteed.

Therefore, it is considered to be a further object of the present disclosure to configure a device for supplying a raw material quantity into a production machine in such a way that supplying the raw material quantity is possible without bridging and thus reliably and continuously.

This object is achieved in that the supply unit has at least one actuating unit with which an actuating movement of the supply channel portion and/or of the feed hopper can be generated, whereby a displacement of the supply channel portion relative to the feed hopper can be effected, so that the raw material quantity supplied to the feed hopper is adjustable at different feed positions within the supply opening, so that a particularly uniform supply of the raw material quantity is possible.

Electrically, pneumatically or hydraulically operated actuators, which are commercially available and in a variety of embodiments, can be used as actuating units. For example, pneumatically driven actuators are available for linear actuating movements with large travel paths of the actuating movement, wherein the travel paths are usually limited by a stop. With such pneumatic actuators, it is also possible to reverse the direction of the actuating movement up to a certain low-frequency switching frequency. By means of electrically operated actuators, such as ultrasonic actuators, high-frequency actuating movements with small travel paths of the actuating movement can be generated.

Such actuating units are often used in the field of conveying bulk materials in order to stimulate the flow of bulk materials in conveying devices along a conveyor line or within supply units. For example, vibrations to excite the conveying equipment are generated by high-frequency vibratory linear actuating movements. Non-linear actuating movements can be generated by actuating units configured as imbalance actuators. Oscillating or circular actuating movements can also be carried out using imbalance actuators.

According to an advantageous configuration, it is provided that an actuating movement that can be generated by the at least one actuating unit causes a displacement of the supply channel portion or of the feed hopper, so that a distance between a longitudinal axis of the supply tube and a longitudinal axis of the feed hopper is adjustable. Thus, depending on the configuration of the supply unit, it may be advantageous to displace either the supply channel portion or the feed hopper. In this case, the change in distance can be generated particularly easily by a linear actuating movement and a displacement of that component that allows a displacement most easily due to the constructive configuration of the supply unit. For example, the supply channel portion on the side of the exit opening can be displaced particularly easily if it is configured as a free end and thus permits displacement.

According to a particularly advantageous configuration, it is provided that an actuating movement that can be generated by the at least one actuating unit causes the displacement and/or a tilting of the supply channel portion or of the feed hopper, so that an inclination angle between a longitudinal axis of the supply channel portion and a longitudinal axis of the feed hopper is adjustable. For example, the supply channel portion can particularly advantageously be pivotably supported on a bearing on one side, so that a displacement of the exit opening of the supply channel portion along a circular path takes place on the other side due to the actuating movement of the actuating unit. Such a displacement of the supply channel portion can be realized particularly easily and with a low constructive and mechanical effort.

Advantageously, it is optionally possible for the lateral distance and/or inclination angle between the longitudinal axis of the supply channel portion and the longitudinal axis of the feed hopper to be adjustable by the displacement and/or tilting of the supply channel portion and the feed hopper, whereby a relative displacement of the supply channel portion and the feed hopper in opposite directions results in an increase in the relative distance. As a result, the adjustable relative distance and/or the adjustable inclination angle can be increased, in particular in a configuration of the supply unit in which the permissible travel paths of the actuating movement of the individual components are mechanically limited to a small travel path, so that the raw material quantity supplied can be distributed at different feed positions within the supply opening.

Furthermore, it is also possible that the actuating movement that can be generated by the at least one actuating unit can be executed in an alternating direction. An oscillating actuating movement of the supply channel portion and/or the feed hopper can be generated particularly easily by an alternating direction actuating movement. The flowability and conveyability of, in particular, poorly flowing raw material quantities or those that are difficult to convey can be increased by an oscillating actuating movement of the supply channel portion carrying the raw material quantity and/or of the feed hopper. In particular, this reduces the risk of bridging and favors a continuous and uniform supply of the raw material quantity into the production machine.

According to a particularly advantageous configuration, it is provided that the travel path of the actuating movement that can be generated by the at least one actuating unit is adjustable. The change in the travel path of the actuating movement can be carried out more advantageously in order to match the displacement of the supply channel portion and the feed opening, for example, with different diameters of the supply channel portion and the feed opening. For example, if the diameter of the exit opening of the supply channel portion is small compared to the feed opening, the supply channel portion can travel a greater travel path relative to the feed opening of the feed hopper so that the raw material quantity can be continuously supplied into the supply hopper during the actuating movement. This makes it particularly advantageous to supply the raw material quantity at different feed positions within the supply opening.

It is also conceivable and advantageous with regard to the greatest possible influenceability of the raw material supply that the speed of the actuating movement that can be generated by the at least one actuating unit is changeable within the travel path of the actuating movement. This allows low-frequency and high-frequency oscillating actuating movements to be realized. The flowability and conveyability of poorly flowable and poorly conveyable raw materials can be increased by means of high-frequency oscillating actuating movements with which the displacement of the supply channel portion and/or the feed hopper is carried out, whereby the risk of bridging can be advantageously reduced.

In an advantageous manner, it is optionally possible that the acceleration of the actuating movement that can be generated by the at least one actuating unit is changeable within the travel path. Through high acceleration of the actuating movement and the displacement of the supply channel portion or the supply hopper, for example, an impacting actuating movement can be realized, whereby bridging can be particularly advantageously avoided.

In addition, a gentle actuating movement can be generated by a slight acceleration of the actuating movement, for example, in order to supply easily flowable raw material quantities to the supply hopper in oscillating movements, so that a particularly continuous and uniform supply of the raw material quantity at different feed positions of the supply hopper is possible.

Furthermore, it is also possible that the diameter of the feed opening of the feed hopper is larger than the diameter of the exit opening of the supply channel portion, whereby particularly long travel paths for the displacement of the supply channel portion or the supply hopper are feasible. This is particularly advantageous for achieving a uniform supply of the raw material quantity in large regions and at different feed positions within the supply opening, so that the risk of bridging can be reduced.

Exemplary configurations of the inventive ideas are explained in more detail below. An exemplary embodiment of the method for supplying the raw material mixture into the extrusion machine is explained in the exemplary embodiment below. The configuration of the supply unit is shown schematically in the drawing in FIG. 1.

### Exemplary Embodiment

A raw material mixture is processed in a raw material mixer into a free-flowing raw material mixture. The raw material mixture consists of a fiber raw material and a carrier raw material. The fiber raw material consists of the press cake, which was created as a process by-product of a juice manufacturing process. The press cake contains the skin, pulp, seeds and the residual juice of berries. The carrier raw material consists of maize and has the components of the whole maize grain, such that the bran, the germ and the endosperm are contained in the carrier raw material. The raw material mixture consists of 80 wt. % fiber raw material and 20 wt. % carrier raw material. Due to the water content of the fiber raw material, the raw material mixture contains 20 wt. % water, which makes the raw material mixture suitable for further processing in the extrusion machine. Adding water or drying the raw material mixture is not necessary. Because of the poor flowability of the raw material mixture due to the fibers and the associated high risk of bridging, it is supplied to the extrusion machine via the moving supply unit. In this case, the raw material mixture is conveyed into the extrusion machine through a supply unit moved in an oscillating manner, whereby bridging during the supply of the raw material mixture is avoided. The extrusion process is carried out with a single-screw extruder. Due to the high proportion of raw material and at the same time high proportion of water within the raw material mixture, extrudate is generated that barely expands after leaving the nozzle, so that hard and fine-pored extrudate is generated. The nozzle is configured in such a way that ring-shaped extrudate is produced. Following the extrusion process, the extrudate is refined with further components. The extrudate is wetted with oil and finally seasoned with table salt. By this refinement of the extrudate, a tasty and appealing food product is manufactured.

### BRIEF DESCRIPTION OF THE DRAWINGS

FIG. 1 shows a schematic representation of a supply unit for supplying a raw material quantity into a production machine.

### DETAILED DESCRIPTION

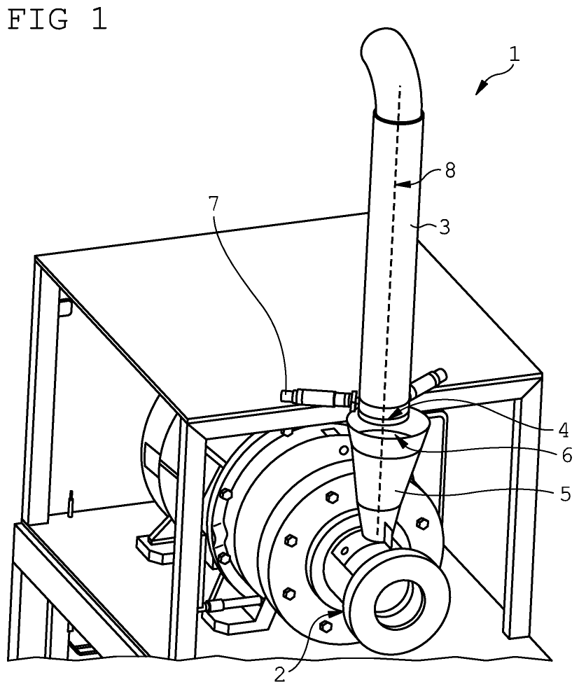

FIG. 1 is a schematic representation of a supply unit 1 for supplying a raw material quantity not shown in FIG. 1 into a production machine 2. The supply unit 1 consists of a supply channel portion 3 having an exit opening 4 and a feed hopper 5 with a feed opening 6. The raw material quantity exits the supply channel portion 3 and is supplied to the production machine 1 via the feed opening 6 of the feed hopper 5. In this case, the supply channel portion 3 in the supply unit 1 is oriented perpendicularly and arranged above the supply hopper 5. Due to the perpendicular arrangement, gravity-assisted conveying can be achieved. In the configuration of the supply unit 1 shown in FIG. 1, two actuating units 7 are arranged in the region of the exit opening 6 on the supply channel portion 3. By arranging the two actuating units 7 in this way, actuating movements can be carried out in different directions perpendicular to the orientation of the supply channel portion 3, whereby a displacement of the exit opening 4 of the supply channel portion 3 can be generated. This allows, for example, a relative distance to be created between a longitudinal axis 8 of the supply channel portion 3 and a longitudinal axis 8 of the feed hopper 5. The feed hopper 5 is fixed to the production machine 2. The diameter of the feed opening 6 of the feed hopper 5 is larger than the diameter of the exit opening 4 of the supply channel portion 3, which determines the maximum permissible travel path for the relative displacement of the supply channel portion 3 from the feed hopper 5 in order to be able to supply the raw material quantity exiting the exit opening 4 of the supply channel portion 3 into the feed opening 6 of the feed hopper 5.

### LIST OF REFERENCE NUMERALS

1. Supply unit

2. Production machine

3. Supply channel portion

4. Exit opening

5. Feed hopper

6. Feed opening

7. Actuating unit

8. Longitudinal axis

1.-21. (canceled)

22. A method for processing a raw material mixture in an extrusion machine for manufacturing a food product, comprising:
supplying the raw material mixture to the extrusion machine by a moved supply unit (1),
wherein the raw material mixture is adjustable at different feed positions within a supply opening by an actuating movement of a supply channel portion (3) and/or a feed hopper (5) of the supply unit (1), which enables a particularly uniform supply of the raw material mixture into the extrusion machine, so that the raw material mixture can be processed by the extrusion machine,
wherein the raw material mixture has a fiber raw material and a carrier raw material,
wherein the fiber raw material has a process by-product of a food manufacturing process, and wherein the carrier raw material has whole-grain components.

23. The method according to claim 22,
wherein the raw material mixture has 5 wt. % to 80 wt. % fiber raw material and 1 wt. % to 95 wt. % carrier raw material.

24. The method according to claim 22,
wherein a proportion of the process by-product in the fiber raw material is 1 wt. % to 100 wt. %.

25. The method according to claim 22,
wherein the process by-product has plant-based raw materials consisting of press cakes, filter cakes, husks and/or spent grains.

26. The method according to claim 22,
wherein the process by-product has 5 wt. % to 20 wt. % water.

27. The method according to claim 22,
wherein the whole-grain components are selected from the group consisting of maize, rice, wheat, barley, rye, oats, spelt, another cereal, and a combination thereof.

28. The method according to claim 22,
wherein the raw material mixture has a further component.

29. The method according to claim 28,
wherein the further component is selected from the group consisting of water, sweetening agents, table salt, fats and oils, functional ingredients, flavors, and combinations thereof.

30. The method according to claim 22,
wherein the raw material mixture supplied to the extrusion machine is extruded with a single-screw extrusion device.

31. A method for supplying a raw material quantity into a production machine (2), comprising:
supplying the raw material quantity into the production machine (2) along a trajectory through the supply opening by a supply unit (1),
changing the trajectory of the raw material quantity such that a trajectory passage angle, at which the trajectory passes through the supply opening and/or a trajectory passage position at which the trajectory passes through the supply opening is changed.

32. The method according to claim 31,
wherein the trajectory passage angle and the trajectory passage position are continuously and/or discontinuously changed during the supplying of the raw material quantity through the supply opening.

33. The method according to claim 32,
wherein changing the trajectory passage angle and changing the trajectory passage position can be carried out at different speeds.

34. A supply unit (1) for supplying a raw material quantity into a production machine (2), comprising:
a supply channel portion (3) having an exit opening (4) and having a feed hopper (5),
wherein the raw material quantity can be conveyed through the exit opening (4) of the supply channel portion (3) into a feed opening (6) of the feed hopper (5) and supplied through the feed hopper (5) to the production machine (2),
wherein the supply unit (1) has at least one actuating unit (7), by which an actuating movement of the supply channel portion (3) and/or of the feed hopper (5) can be generated, so that the supply channel portion (3) can be caused to displace relative to the feed hopper (5).

35. The supply unit (1) according to claim 34,
wherein an actuating movement that can be generated by the at least one actuating unit (7) causes a displacement of the supply channel portion (3) or of the feed hopper (5), so that a distance between a longitudinal axis (8) of a supply tube and a longitudinal axis (8) of the feed hopper (5) is adjustable.

36. The supply unit (1) according to claim 34,
wherein an actuating movement that can be generated by the at least one actuating unit (7) causes a displacement and/or a tilting of the supply channel portion (3) or of the feed hopper (5), so that an inclination angle between a longitudinal axis (8) of the supply channel portion (3) and a longitudinal axis (8) of the feed hopper (5) is adjustable.

37. The supply unit (1) according to claim 34,
wherein a lateral distance and/or an inclination angle between a longitudinal axis (8) of the supply channel portion (3) and the longitudinal axis (8) of the feed hopper (5) is adjustable by displacement and/or tilting of the supply channel portion (3) and of the feed hopper (5).

38. The supply unit (1) according to claim 34,
wherein the actuating movement that can be generated by the at least one actuating unit (7) can be executed in an alternating direction.

39. The supply unit (1) according to claim 34,
wherein a travel path of the actuating movement that can be generated by the at least one actuating unit (7) is adjustable.

40. The supply unit (1) according to claim 39,
a speed of the actuating movement that can be generated by the at least one actuating unit (7) is changeable within the travel path.

41. The supply unit (1) according to claim 39,
wherein an acceleration of the actuating movement that can be generated by the at least one actuating unit (7) is changeable within the travel path.

42. The supply unit (1) according to claim 34,
wherein a diameter of the feed opening (6) of the feed hopper (5) is larger than a diameter of the exit opening (4) of the supply channel portion (3).
